(19) United States
(12) Patent Application Publication
(10) Pub. No.: US 2023/0164528 A1
(43) Pub. Date: May 25, 2023

(54) V2X MESSAGE PROCESSING APPARATUS AND METHOD

(71) Applicant: Ways1 Inc., Gyeonggi-do (KR)

(72) Inventor: Jae Hee Kim, Gyeonggi-do (KR)

(21) Appl. No.: 17/646,105

(22) Filed: Dec. 27, 2021

(30) Foreign Application Priority Data
Nov. 25, 2021 (KR) 10-2021-0164352

(51) Int. Cl. H04W 4/40

(52) U.S. Cl. CPC H04W 4/40

(57) ABSTRACT

Disclosed are an apparatus for processing a vehicle-to-everything (V2X) message. The apparatus includes a precise road map storage unit configured to store a precise road map and a map message processing unit configured to generate a MAP message for a real-time traffic signal phase information service using the precise road map and divide the MAP message according to the size of the MAP message.

### CROSS-REFERENCE TO RELATED APPLICATION

This application claims priority to and the benefit of Korean Patent Application No. 10-2021-0164352, filed on Nov. 25, 2021, the disclosure of which is incorporated herein by reference in its entirety.

### BACKGROUND

### 1. Field of the Invention

The present invention relates to a vehicle-to-everything (V2X) message processing apparatus and method, and more particularly, to a V2X message processing apparatus and method capable of dividing a MAP message for a single intersection and road section into a plurality of MAP messages according to the size of the MAP message and delivering the plurality of MAP messages.

### 2. Discussion of Related Art

In general, autonomous vehicles collect vehicle operation support information to understand surrounding traffic conditions.

Roadside infrastructure equipment collects traffic signal status information from traffic signal controllers according to a traffic signal controller standard. The traffic signal controller standard is defined as providing a traffic light status and signal display contents (output type) for each intersection entry direction (direction code according to a map matching scheme) along with time information. In addition, roadside infrastructure equipment provides traffic signal information of an intersection to autonomous vehicles scheduled to pass through the intersection through wireless communication in the format of a Signal Phase and Timing (SPaT) message and a map message of SAE J2735.

In particular, Local Dynamic Map (LDM) among roadside infrastructure equipment connects, stores, and manages standardized vehicle operation support information for autonomous cooperative driving from a traffic signal controller, and also collects various kinds of real-time information of road infrastructure, processes information for V2X service according to SAE J2735 standard using a precise map, and provides the processed information.

The background technology of the present invention is disclosed in Korean Patent Publication No. 10-2020-0134136, entitled “PATH PROVIDING DEVICE AND PATH PROVIDING METHOD THEREOF” and published on Dec. 1, 2020.

### SUMMARY OF THE INVENTION

The MAP message of the conventional SAE J2735 is used to encode a precise road map with units of lanes in a standard specification and deliver the precise road map from infrastructure to a vehicle through V2X wireless communication. The MAP message is defined to be generated in units of a road intersection or a road section.

Upon receiving the MAP message, a vehicle may decode the MAP message and then correct location information of vehicles with longitude and latitude coordinates and nearby objects or identify locations on the map with units of lanes.

However, the MAP message of SAE J2735 is used to encode a precise road map with units of lanes in a standard specification and deliver the encoded map from infrastructure to a vehicle through V2X wireless communication. When the MAP message is greater than a size that can be transmitted by WAVE communication, there is a program in that a communication failure such as a delay in transmitting the MAP message occurs.

The present invention is designed to solve the above problems, and an object according to an aspect of the present invention is to provide a V2X processing apparatus and method for dividing a MAP message for a signal intersection or road section into a plurality of MAP messages according to the size of the MAP message and delivering the MAP messages.

According to an aspect of the present invention, there is provided an apparatus for processing a vehicle-to-everything (V2X) message, the apparatus including a precise road map storage unit configured to store a precise road map and a map message processing unit configured to generate a MAP message for a real-time traffic signal phase information service using the precise road map and divide the MAP message according to the size of the MAP message.

The MAP message processing unit may include a MAP message generation unit configured to generate a MAP message using the precise road map and a comparison unit configured to compare the size of the MAP message generated by the MAP message generation unit to a preset message size, and the MAP message generation unit may divide the MAP message according to a result of the comparison by the comparison unit.

The MAP message generation unit may generate a MAP message by adding a GenericLane entity to IntersectionGeometry data frame or RoadSegment data frame.

Whenever a MAP message is generated based on the GenericLane entity, the comparison unit may compare the size of the MAP message to the preset message size.

The MAP message generation unit may divide the MAP message into a plurality of MAP messages within the range of the preset message size according to a result of the comparison by the comparison unit.

The preset message size may be set according to a communication standard of a communication scheme for transmitting a MAP message.

The apparatus may further include a communication unit configured to deliver the MAP messages generated by the MAP message processing unit to a receiving side.

The communication unit may deliver the total number of MAP messages and a serial number recorded in a currently transmitted MAP message.

According to an aspect of the present invention, there is provided a method of processing a vehicle-to-everything (V2X) message, the method including operations of: allowing a MAP message processing unit to generate a MAP message using a precise road map, allowing a comparison unit to compare the size of the MAP message generated by the MAP message processing unit to a preset message size, and allowing the MAP message processing unit to divide the MAP message according to a result of the comparison by the comparison unit.

In the operation of allowing a MAP message processing unit to generate a MAP message, the MAP message processing unit may generate the MAP message by adding a GenericLane entity to IntersectionGeometry data frame or RoadSegment data frame.

In the operation of allowing a comparison unit to compare the size of the MAP message generated by the MAP message processing unit to a preset message size, the comparison unit may compare the size of the MAP message to the preset message size whenever the MAP message is generated based on the GenericLane entity.

In the operation of allowing the MAP message processing unit to divide the MAP message according to a result of the comparison by the comparison unit, the MAP message processing unit may divide the MAP message into a plurality of MAP messages within the range of the preset message size according to a result of the comparison by the comparison unit.

The preset message size may be set according to a communication standard of a communication scheme for transmitting a MAP message.

The method may further include an operation of allowing a communication unit to deliver the MAP messages generated by the MAP message processing unit to a receiving side.

In the operation of allowing a communication unit to deliver the MAP messages generated by the MAP message processing unit to a receiving side, the communication unit may deliver the total number of MAP messages and a serial number recorded in a currently transmitted MAP message.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a vehicle-to-everything (V2X) message processing apparatus according to an embodiment of the present invention;

FIG. 2 is a diagram illustrating an example of dividing a general road section;

FIG. 3 is a diagram showing a precise road map of the vicinity of a tollgate;

FIG. 4 is an exemplary diagram of a precise road map of an intersection according to an embodiment of the present invention;

FIG. 5 is an exemplary diagram of a precise road map of a road section according to an embodiment of the present invention;

FIG. 6 is a diagram showing an example of a MAP message obtained through division according to an embodiment of the present invention; and

FIG. 7 is a flowchart of a V2X message processing method according to an embodiment of the present invention.

### DETAILED DESCRIPTION OF EXEMPLARY EMBODIMENTS

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereinafter, an apparatus and method for processing a vehicle-to-everything (V2X) message according to an embodiment of the present invention will be described in detail with reference to the accompanying drawings. In the drawings, thicknesses of lines or sizes of elements may be exaggerated for clarity and convenience. Also, the following terms are defined considering functions of the present invention, and may be differently defined depending on a user, the intent of an operator, or a custom. Therefore, the terms should be defined based on overall content of the specification.

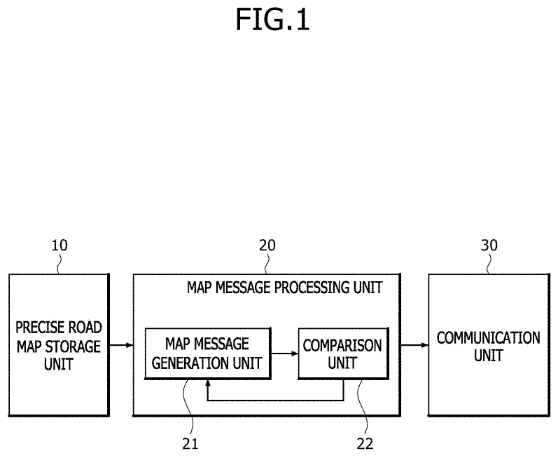

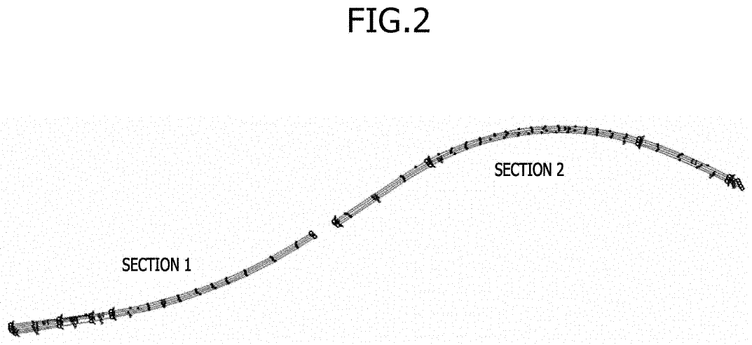

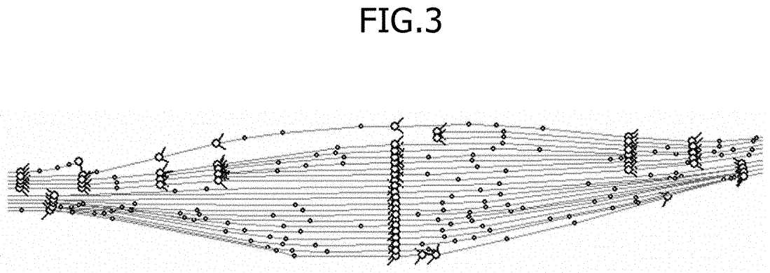

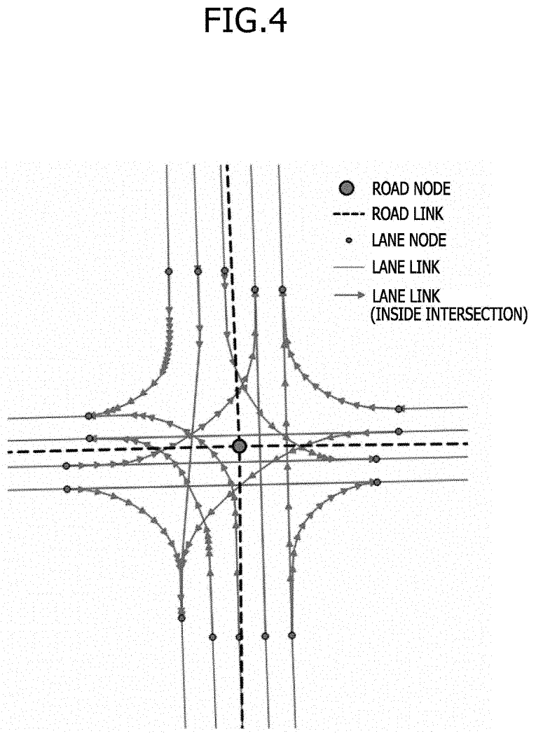

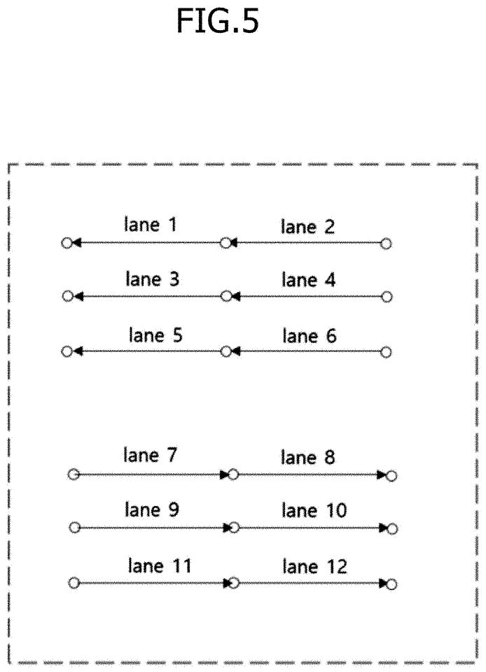

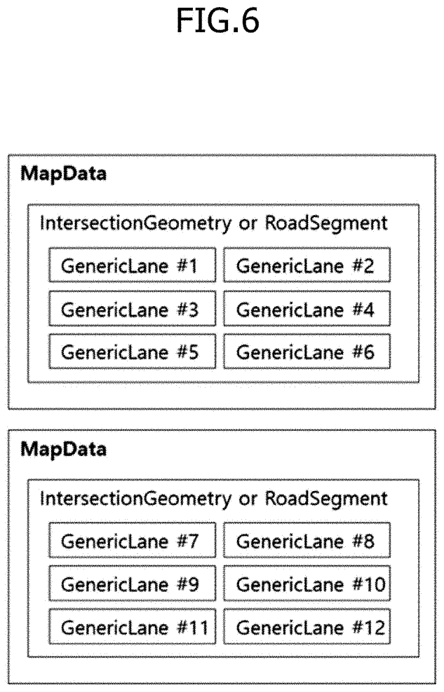

FIG. 1 is a block diagram of a vehicle-to-everything (V2X) message processing apparatus according to an embodiment of the present invention. FIG. 2 is a diagram illustrating an example of dividing a general road section. FIG. 3 is a diagram showing a precise road map of the vicinity of a tollgate. FIG. 4 is an exemplary diagram of a precise road map of an intersection according to an embodiment of the present invention. FIG. 5 is an exemplary diagram of a precise road map of a road section according to an embodiment of the present invention. FIG. 6 is a diagram showing an example of a MAP message obtained through division according to an embodiment of the present invention.

Referring to FIG. 1, the V2X message processing apparatus according to an embodiment of the present invention includes a precise road map storage unit 10, a MAP message processing unit 20, and a communication unit 30.

The precise road map storage unit 10 stores precise road maps.

The precise road maps may be, for example, precise road maps of the Korea National Geographic Information Institute, but the present invention is not limited thereto.

The precise road maps are maps obtained by modeling road objects such as lanes, stop lines, road signs, and road facilities in three dimensions and producing the shape and the attachment information as spatial data. The precise road maps include a network that expresses the driving routes of vehicles by lane in a node-link structure.

The MAP message processing unit 20 generates a MAP message for a real-time traffic signal phase information service using a precise road map. In this case, the MAP message processing unit 20 divides the MAP message according to the size of the MAP message.

A receiving side may be a nearby autonomous vehicle, Cooperative Intelligent Transport Systems (C-ITS) vehicle, connected car, etc., but the present invention is not limited thereto.

In this case, the autonomous vehicle or the C-ITS vehicle may use a MAP message for vehicle driving.

The MAP message is delivered according to the SAE J2735 standard.

The SAE J2735 standard includes a message layer and defines a set of Dedicated Short Range Communication (DSRC) messages transmitted and received between vehicles or between vehicles and infrastructure. That is, the SAE J2735 standard defines, through the MAP message, a road section or an entry or exit lane of an intersection for which a traffic signal information service is to be provided.

The MAP message processing unit 20 includes a MAP message generation unit 21 and a comparison unit 22.

The MAP message generation unit 21 generates a MAP message using the precise road maps stored in the precise road map storage unit 10.

In this case, the MAP message generation unit 21 may generate the MAP message by adding a GenericLane entity to IntersectionGeometry data frame or RoadSegment data frame.

In order to generate a MAP message using a road on a precise road map, as shown in FIG. 2, the MAP message generation unit 21 may divide the road into sections by a preset length in a traveling direction of the road and generate a message for each section.

The road sections may be obtained through the division according to installation intervals of Wireless Access in Vehicular Environment (WAVE) base stations that are installed on roadsides to transmit MAP messages. For example, when the WAVE base stations are installed at intervals of 1 km along the road, the MAP message generation unit 21 may generate a MAP message for a road section with a distance of 1 km around the WAVE base station.

Also, as shown in FIG. 4, in the case of a section where many objects are to be generated due to a large number of lanes, the MAP message generation unit 21 may generate a MAP message for a road section with a relatively shorter distance than the installation interval of the WAVE base station.

Furthermore, the MAP message generation unit 21 may divide the road into sections by a preset length in the traveling direction of the road and generate a message for each section or generate a MAP message for a road section having a relatively shorter distance than the installation interval of the WAVE base station. In this case, the MAP message generation unit 21 divides the MAP message according to the size of the MAP message when the corresponding MAP message has a size greater than a preset MAP message size.

The MAP message includes IntersectionGeometry data frame (in the case of an intersection) or RoadSegment data frame (in the case of a road section).

Each of the IntersectionGeometry data frame and the RoadSegment data frame includes a plurality of GenericLane data frames.

First, when generating a MAP message using a precise road map of an intersection, the MAP message generation unit 21 generates a MAP message for each GenericLane entity by adding the GenericLane entities to the IntersectionGeometry data frame.

That is, the MAP message generation unit 21 generates a lane link group by grouping lane links on a precise road map corresponding to an entry to and an exit from an intersection having a traffic light and generates a MAP message by assigning a signal group number to each lane link group.

The MAP message generation unit 21 extracts a road node of an intersection from a navigation road map. The MAP message generation unit 21 extracts a road node expressing an intersection point from the entire area of the map. In particular, the MAP message generation unit 21 extracts a road node corresponding to a traffic signal intersection on the basis of an attribute for distinguishing an intersection having a traffic light installed thereon among attribute information of the road node, that is, on the basis of whether there is a traffic signal intersection.

The MAP message generation unit 21 extracts a road link of the navigation road map connected to the extracted road node and calculates an intersection entry direction angle and an intersection exit direction angle of the extracted road link.

Subsequently, the MAP message generation unit 21 generates lane link groups by grouping lane links corresponding to an entry to and an exit from the intersection on the basis of the extracted road node and generates a MAP message by sequentially assigning signal group numbers to the lane link groups.

In this case, the MAP message generation unit 21 generates the intersection exit lane links or intersection entry lane links connected to the internal lane links of the intersection as GenericLane entities of the MAP message and encodes the generated MAP message in order to deliver the MAP message through the communication unit 30.

Subsequently, when generating a MAP message using a precise road map of a road section, the MAP message generation unit 21 generates a plurality of lanes in the road section as a GenericLane entity of the MAP message.

Referring to FIG. 5, an example is shown in which the MAP message generation unit 21 generates a MAP message by sequentially including 12 lanes in the road section starting from Lane 1.

Whenever a MAP message is generated based on the GenericLane entity, the comparison unit 22 compares the size of the MAP message to a preset message size and delivers a result of the comparison to the MAP message generation unit 21.

The preset message size may be set according to a communication standard of a communication scheme for transmitting a MAP message, and the present invention is not limited thereto.

In a process of generating the MAP message, the MAP message generation unit 21 may divide the MAP message into a plurality of MAP messages within the range of the preset message size according to a result of the comparison by the comparison unit 22.

That is, the MAP message generation unit 21 may divide the MAP message into a plurality of MAP messages such that the size of the MAP message is included in the range of the preset message size.

Referring to FIG. 6, an example is shown in which, for a road section having 12 lanes, the MAP message generation unit 21 generates a MAP message including lanes 1 to 6 and separately generates a MAP message including lanes 7 to 12 within the range where the size of the encoded map data is smaller than the preset message size.

The communication unit 30 delivers the MAP messages to a receiving side on the basis of V2X communication technology.

In this case, the communication unit 30 delivers the total number of MAP messages and a serial number recorded in a currently transmitted MAP message to a receiving side. In this case, for the J2735 MAP message, the communication unit 30 may load the total number of MAP messages and the serial number of the currently transmitted MAP message in dataParameters field in MapData.

Accordingly, the receiving side may use the corresponding MAP message by collecting and merging the MAP messages on the basis of the total number of MAP messages and the serial number of the currently transmitted MAP message.

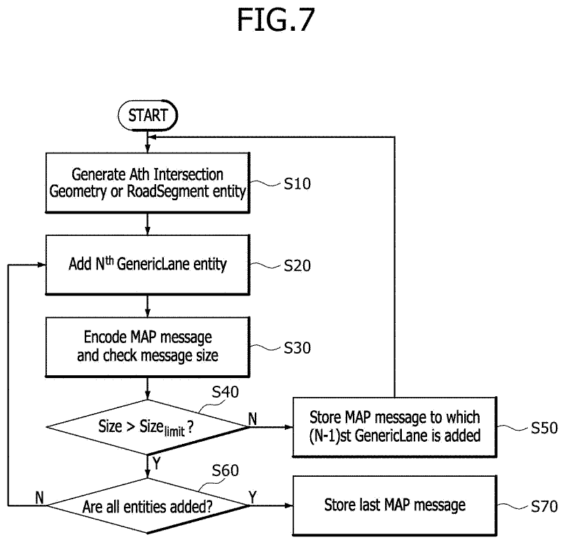

A V2X message processing method according to an embodiment of the present invention will be described below in detail with reference to FIG. 7.

FIG. 7 is a flowchart of the V2X message processing method according to an embodiment of the present invention.

Referring to FIG. 7, a precise road map storage unit 10 delivers a precise road map to a MAP message processing unit 20.

Here, the precise road map is a map obtained by modeling road objects such as lanes, stop lines, road signs, and road facilities in three dimensions and producing the shape and the attachment information as spatial data.

A MAP message may be generated by adding a GenericLane entity to IntersectionGeometry data frame or RoadSegment data frame.

Thus, the MAP message generation unit 21 generates a GenericLane entity in the IntersectionGeometry data frame or the RoadSegment data frame (S10).

For example, when generating a MAP message using a precise road map for an intersection, the MAP message generation unit 21 extracts a road node of the intersection from the navigation road map and extracts a road node expressing the intersection point in the entire area of the map.

Subsequently, the MAP message generation unit 21 extracts a road link of the navigation road map connected to the extracted road node and calculates an intersection entry direction angle and an intersection exit direction angle of the extracted road link.

Subsequently, the MAP message generation unit 21 generates lane link groups by grouping lane links corresponding to an entry to and an exit from the intersection on the basis of the extracted road node and generates a MAP message by sequentially assigning signal group numbers to the lane link groups.

In this case, the MAP message generation unit 21 generates the intersection exit lane links or intersection entry lane links connected to the internal lane links of the intersection as GenericLane entities of the MAP message (S20).

Meanwhile, when generating a MAP message using a precise road map of a road section, the MAP message generation unit 21 generates a plurality of lanes in the road section as GenericLane entities of the MAP message.

That is, the MAP message generation unit 21 generates a MAP message for a plurality of lanes in the road section and generates the lanes as GenericLane entities.

Subsequently, the MAP message generation unit 21 encodes the MAP message and checks the size of the encoded MAP message (S30).

By checking the size of the MAP message, the comparison unit 22 compares the size of the corresponding MAP message to a preset message size (S40) and delivers a result of the comparison to the MAP message generation unit 21.

Accordingly, when the result of the comparison by the comparison unit 22 is that the size of the MAP message is not greater than the preset message size, the MAP message generation unit 21 stores the MAP message. In this case, the MAP message generation unit 21 stores the MAP message within the range of the preset message size (a MAP message to which an (N-1)st GenericLane entity is added) (S50).

Meanwhile, when the comparison result in operation S40 is that the size of the MAP message is greater than the preset message size, the MAP message generation unit 21 adds all of the GenericLane entities and stores a MAP message including the Nth to the last GenericLane entities (within the range of the preset message size) (S60) (S70).

For reference, according to this embodiment, the division of the map message into two messages has been described as an example, but the technical scope of the present invention is not limited thereto, and the map message may be divided into more messages.

That is, whenever the MAP message is generated based on the GenericLane entities, the comparison unit 22 compares the size of the MAP message to the preset message size.

In this case, the MAP message generation unit 21 divides the MAP message into a plurality of MAP messages within the range of the preset message size according to a result of the comparison by the comparison unit 22 and delivers the MAP messages to a receiving side.

In this case, the communication unit 30 delivers the total number of MAP messages and a serial number recorded in a currently transmitted MAP message to a receiving side.

As described above, when the V2X message processing apparatus and method according to an embodiment of the present invention convert a precise road map into a MAP message for V2X service, a transmitting side may divide a single intersection or road section into two or more sections and convert the sections, and a receiving side may merge messages to restore the precise road map, thus enabling a MAP message to be effectively delivered according to a road range.

The V2X message processing apparatus and method according to an aspect of the present invention enable effective map message delivery according to a road range by dividing a MAP message for a single intersection or road section into a plurality of MAP messages according to the size of the MAP message.

The implementations described herein may be implemented in, for example, a method or a process, an apparatus, a software program, a data stream, or a signal. Even if only described in the context of a single form of implementation (for example, discussed only as a method or a device), the implementation of features discussed may also be implemented in other forms (for example, a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, smartphones, tablets, computers, mobile phones, portable/personal digital assistants (PDAs), and other devices that facilitate communication of information between end-users.

While the present invention has been described with reference to an embodiment shown in the accompanying drawings, it should be understood by those skilled in the art that this embodiment is merely illustrative of the invention and that various modifications and equivalents may be made without departing from the spirit and scope of the invention. Therefore, the technical scope of the present invention should be defined by the appended claims.

What is claimed is:

1. An apparatus for processing a vehicle-to-everything (V2X) message, the apparatus comprising:
a precise road map storage unit configured to store a precise road map; and
a map message processing unit configured to generate a MAP message for a real-time traffic signal phase information service using the precise road map and divide the MAP message according to the size of the MAP message.

2. The apparatus of claim 1, wherein
the MAP message processing unit comprises:
a MAP message generation unit configured to generate a MAP message using the precise road map; and
a comparison unit configured to compare the size of the MAP message generated by the MAP message generation unit to a preset message size, and
the MAP message generation unit divides the MAP message according to a result of the comparison by the comparison unit.

3. The apparatus of claim 2, wherein the MAP message generation unit generates a MAP message by adding a GenericLane entity to IntersectionGeometry data frame or RoadSegment data frame.

4. The apparatus of claim 3, wherein whenever a MAP message is generated based on the GenericLane entity, the comparison unit compares the size of the MAP message to the preset message size.

5. The apparatus of claim 4, wherein the MAP message generation unit divides the MAP message into a plurality of MAP messages within the range of the preset message size according to a result of the comparison by the comparison unit.

6. The apparatus of claim 2, wherein the preset message size is set according to a communication standard of a communication scheme for transmitting a MAP message.

7. The apparatus of claim 1, further comprising a communication unit configured to deliver the MAP messages generated by the MAP message processing unit to a receiving side.

8. The apparatus of claim 7, wherein the communication unit delivers the total number of MAP messages and a serial number recorded in a currently transmitted MAP message.

9. A method of processing a vehicle-to-everything (V2X) message, the method comprising operations of:
allowing a MAP message processing unit to generate a MAP message using a precise road map;
allowing a comparison unit to compare the size of the MAP message generated by the MAP message processing unit to a preset message size; and
allowing the MAP message processing unit to divide the MAP message according to a result of the comparison by the comparison unit.

10. The method of claim 9, wherein in the operation of allowing a MAP message processing unit to generate a MAP message,
the MAP message processing unit generates the MAP message by adding a GenericLane entity to IntersectionGeometry data frame or RoadSegment data frame.

11. The method of claim 10, wherein in the operation of allowing a comparison unit to compare the size of the MAP message generated by the MAP message processing unit to a preset message size,
the comparison unit compares the size of the MAP message to the preset message size whenever the MAP message is generated based on the GenericLane entity.

12. The method of claim 11, wherein in the operation of allowing the MAP message processing unit to divide the MAP message according to a result of the comparison by the comparison unit,
the MAP message processing unit divides the MAP message into a plurality of MAP messages within the range of the preset message size according to a result of the comparison by the comparison unit.

13. The method of claim 9, wherein the preset message size is set according to a communication standard of a communication scheme for transmitting a MAP message.

14. The method of claim 9, further comprising an operation of allowing a communication unit to deliver the MAP messages generated by the MAP message processing unit to a receiving side.

15. The method of claim 14, wherein in the operation of allowing a communication unit to deliver the MAP messages generated by the MAP message processing unit to a receiving side,
the communication unit delivers the total number of MAP messages and a serial number recorded in a currently transmitted MAP message.
